(19) United States
(12) Patent Application Publication
(10) Pub. No.: US 2024/0121861 A1
(43) Pub. Date: Apr. 11, 2024

(54) METHOD FOR PRODUCING A TUBULAR HEATING CARTRIDGE FOR ELECTRICAL HEATING DEVICES, HEATING ELEMENT BLANK FOR SUCH A HEATING CARTRIDGE, AND A HEATING CARTRIDGE

(71) Applicant: Türk & Hillinger GmbH, Tuttlingen (DE)

(72) Inventor: Andreas SCHLIPF, Tuttlingen (DE)

(21) Appl. No.: 18/276,268

(22) PCT Filed: Feb. 7, 2022
(86) PCT No.: PCT/EP2022/052864

§ 371 Date: Aug. 8, 2023

(30) Foreign Application Priority Data
Feb. 8, 2021 (DE) 10 2021 102 894.9

(51) Int. Cl. H05B 3/44

(52) U.S. Cl. CPC H05B 3/44

(57) ABSTRACT

A method for producing a tube-shaped heating cartridge includes preparation of a plate-shaped or tube-shaped, electrically conductive body, machining the body for forming a heating element blank such that a deformable heating conductor path structure is formed from the body with a first total length and a first height and also with at least one first and second conductor path end, inserting the heating element blank into a tube-shaped metal housing, which has a second total length and a second height, filling the tube-shaped metal housing with an electrically insulating and compactable material and compacting the filled metal housing for achieving a specified geometric shape and a specified ohmic resistance of the heating element blank with a third total length increased relative to the first total length and a third height reduced relative to the first height.

### CROSS-REFERENCE TO RELATED APPLICATIONS

This application is a Section 371 of International Application No. PCT/EP2022/052864, filed Feb. 7, 2022, which was published in the German language on Aug. 11, 2022 under International Publication No. WO 2022/167649 A1 and claims priority under 35 U.S.C. § 119(b) to German Patent Application No. 10 2021 102 894.9, filed on Feb. 8, 2021, the disclosures of which are incorporated herein by reference in their entirety.

### BACKGROUND OF THE INVENTION

Electrical heating cartridges have been known for many years. They typically have at least one tube-shaped metal jacket, in whose interior at least one heating conductor is arranged. Here, the space between the heating conductor and metal jacket is often filled with a material with good heat-conducting, but electrically insulating, properties, e.g., magnesium oxide, in order to avoid undesired electrical contact between the heating conductor and metal jacket. In this respect, heating cartridges are known today that have at least two supply lines to the heating conductor protruding from one side of the metal jacket. There are also, however, heating cartridges in use in which at least one supply line to the heating conductor protrudes from each of the end faces of the heating cartridge. In addition, heating cartridges are known in which the metal housing itself serves as one of the supply lines.

One example of known heating cartridges and their production method is disclosed in German Patent Application Publication No. DE 10 2013 2012 205 A1.

One essential element of these heating cartridges is the heating conductor located in the interior of the metal jacket or metal housing.

These electrical heating elements, which convert electrical energy into heat, are usually produced from heating conductor material in the form of a wire and this wire—if it is not intended for use in an elongated state—is then wound or coiled by being either bent around a carrier or shaped into a free-standing space curve.

Apart from the problem that not every conceivable or desirable space curve can be generated in this way for such heating elements, there are particular problems in configurations in which small heating conductor resistances have to be accommodated in a very small space due to high heating conductor cross sections. It is necessary that alternating thermal loads are withstood over long periods of time and that unheated zones and heated zones for an electrical heating device are connected to one another in a process-reliable manner, which is essential in the case of very high current loads, high surface loads, and high power densities.

### BRIEF SUMMARY OF THE INVENTION

The object of the preferred invention is to specify a method that is very simple in terms of production technology and is therefore cost-effective for the production of a tube-shaped heating cartridge that is also very small in size and is also suitable for lessening the aforementioned problems for electrical heating devices. The method should ensure reproducible electrical values for the heating cartridge in the simplest possible way, i.e., it should be suitable, in particular, for mass production.

The preferred object is achieved by a method for producing a tube-shaped heating cartridge as described herein. Advantageous refinements of the preferred invention are the subject matter of the detailed description in the specification.

Another object of the preferred invention is to provide a suitable heating element or a suitable heating element blank which can be used in a simple manner for the aforementioned method.

The method according to the preferred invention for producing a tube-shaped heating cartridge for electrical heating devices is characterized by the following method steps:
providing, in particular, a plate-shaped, tube-shaped, or profiled electrically conductive body,
machining the body to form a heating element blank in such a way that a deformable heating conductor path structure with a first overall length and a first height and with at least a first and a second conductor path end is formed from the body,
inserting the heating element blank into the tube-shaped metal housing, which has a second overall length and a second height,
filling the tube-shaped metal housing with an electrically insulating and compactable material, and
compacting the filled metal housing to achieve the specified geometric shape and the specified ohmic resistance of the heating element blank and/or the heating cartridge with a third overall length that is increased relative to the first overall length and/or a third height that is reduced relative to the first height and/or for forming the metal housing a fourth overall length that is increased relative to the second overall length and/or a fourth height that is reduced relative to the second height.

These measures ensure, on one hand, that the heating conductor is cut out of a particularly tube-shaped, profiled, or plate-shaped body and the heating conductor is therefore suitable for mass production. This also means that the circular cross-sectional structure of the heating conductor, which is necessary with conventional heating conductor wires, can be abandoned. Depending on the thickness of the plate-shaped or tube-shaped walls and depending on the cutting contour, it is possible to use almost any cross-sectional shape to realize the heating conductor for the element to be inserted into the heating cartridge. A wide variety of helical structures, e.g., meandering or bifilar structures, can also be realized with this measure.

According to the preferred invention, a heating element blank, which can be mass-produced in this manner, and which has a specific length and height, is inserted into the interior of the tube-shaped metal housing. Electrically insulating material, for example insulating granulate, in particular magnesium oxide granulate, ceramic granulate, or boron nitride granulate, is then filled into the tube-shaped metal housing. However, instead of this insulating granulate, it is also possible to fill the space between the heating element blank and the metal housing with a tube-shaped, porous ceramic material. A porous ceramic rod, in particular, can also be inserted into the intermediate space of the heating element blank.

During a subsequent compaction process, i.e., the tube-shaped metal housing filled in this way is exposed to high external pressure, the insulating granules or the porous ceramic material is compacted and bonded in such a way that the final desired geometric shape of the heating element blank and/or the tube-shaped heating cartridge with the metal housing and thus the electrical values can also be set to the desired final size.

As part of this compaction with extremely high pressures, the geometric shape of the heating element blank usually changes to an overall length that is increased relative to the original heating element blank. However, the height or the diameter of the heating element blank is always reduced after compacting relative to the height of the heating element blank previously inserted into the metal housing. The same thing happens with the tube-shaped metal housing of the cartridge heating device. After compaction, the heating cartridge with its metal housing usually has an increased length but is always reduced in height or diameter. The ohmic resistance of the heating element blank or the heating cartridge usually increases.

The method according to the preferred invention for producing the heating cartridge is designed in such a way as to achieve the desired geometric shape, in particular, of the metal housing and its ohmic setpoint values.

It has proven to be expedient, preferably, to close the metal housing with a cover before compacting.

Before closing, it is preferred that sufficient material to be compacted is filled into the metal housing so that no empty spaces or poorly compacted areas are produced within the metal housing in order to achieve optimum compaction and thus good heat transfer from the heating element blank to the metal housing. During this compaction, the insulating material, which is usually in the form of granules, such as magnesium oxide granules, as mentioned, is compacted and bonded about ten to fifteen percent (10% to 50%) more than its original density. Before or during the actual compaction, it has proven to be expedient to repeatedly vibrate the metal housing with the inserted heating element blank and the insulating material. This vibrating ensures a good, even distribution of the insulating granules and a high bulk density within the metal housing.

It has also turned out to be advantageous that the insulating granules lie with an increased degree of filling inside the metal housing after compacting using the method according to the preferred invention, thereby optimally covering the cut edges of the heating element blank. The result is optimal heat dissipation from the cut edges of the heating element blank to the metal housing.

In one preferred refinement of the invention, it is provided that the heating element blank is cut from a plate-shaped body. The heating conductor path structure is first cut from the plate-shaped body and in a subsequent step the cut or etched out heating conductor path structure is suitably bent in order to provide the ultimately desired structure and shape of a heating element blank. In this case, a heating conductor path structure can be cut out of the plate-shaped body, which has, for example, two meandering heating conductor paths connected via a connecting web and these two heating conductor path structures each have line ends. The two heating conductor path structures are then bent in an arc, preferably around a central axis, and a bend of 180° is additionally provided on the connecting web. In this way, very small heating element blanks can be produced.

Suitable heating element blanks, as can be cut from plate-shaped or tube-shaped bodies, are described in detail in the applicant's German Patent Application No. DE 10 2019 127 753.1.

For the purpose of disclosure, reference is made here in its entirety to this German patent application and the heating element blanks described therein and their production methods are incorporated into the present patent application by reference.

In one preferred refinement of the invention, it is provided that suitable contact terminals are connected to the conductor path ends of the heating element blank, which protrude from the metal housing of the heating cartridge at the front. In this case, the contact terminals cannot only protrude from one longitudinal end of the heating cartridge, but also from both ends.

According to one preferred refinement of the invention, the heating element blank can be made from the plate-shaped or tube-shaped body by means of laser cutting, water jet cutting, micro water jet cutting, etching, punching, sawing, milling, drilling, turning, grinding, or the like. Particularly fine cuts and thus little loss of material are possible using laser cutting, etching, and micro water jet cutting.

It is within the scope of the method according to the preferred invention that the compaction takes place in such a way that the length of the heating element blank and/or the metal housing of the heating cartridge increases, e.g., from approximately one percent (1%) to approximately twenty-five percent (25%) and/or the height reduces, e.g., from approximately three percent (3%) to approximately forty-five percent (45%).

It is within the scope of the preferred present invention that the heating element blank has slots with opposing cut surfaces which are arranged orthogonal to the tube-shaped wall of the metal housing. The cut surfaces are parallel to each other. On the other hand, the slots can also be chosen so that they are orthogonal to a plane of the tube-shaped wall of the metal housing at an angle α parallel to each other or also at different angles to each other.

In addition, it is advantageous according to the preferred invention that the heating element blank is provided with an enlarged surface structure after its processing or after assembly, because the heating element blank has unevenly distributed indented features on its surfaces and also on its cut surfaces after compaction. These indented features ensure a larger, heat-dissipating surface of the strip heating conductor or the heating insert. This is achieved by a positive flow of heat between the heating element blank and the insulating material. The compaction also ensures a high contact pressure and a larger heat-transfer surface between the heating element blank and the insulating material, which ensures that the entire heating cartridge and its contents are firmly fixed in place. Such good fixation is necessary because the heating cartridges are regularly exposed to vibrations, impacts, and alternating thermal stresses and without this good fixation it would be possible for the components inside the heating cartridge to move.

It is within the scope of the preferred invention that, in one special embodiment, the heating element blank formed from a plate-shaped or tube-shaped electrically conductive body is coated with a ceramic material before it is inserted into the metal housing. A porous ceramic material is preferred for this coating. Such a ceramic coating of the heating element blank makes it possible during the manufacturing process of the heating cartridge to eliminate centering devices that were previously necessary when assembling the heating cartridge. In the past, in order to center the structure of cartridge heating devices, the heating insert, i.e., the heating element blank, had to be kept at a sufficient distance from the base of the cartridge and from the wall of the jacket housing.

This was achieved through the use of special filling machines with centering devices, or the use of ceramic spacers. Within the scope of the preferred invention, it is possible to apply such a ceramic coating to the heating element blank and then to ensure good bonding of this ceramic coating to the heating element blank by means of a heat treatment step, optionally by baking or annealing. In principle, it is also possible to apply another insulating layer to the heating element blank before inserting it into the metal housing of the heating cartridge. However, a ceramic layer has proven to be particularly good.

In the context of the present preferred invention, only heating cartridges, which consist of a simple metal tube as a metal housing and are closed at the end with a cover, have been discussed. However, it is also within the scope of the preferred invention to use so-called hollow cartridges as the metal housing for the heating cartridge. Such hollow cartridges are characterized by a double-walled tube, with the heating element blank and the insulating material mentioned being filled in between an inner tube and an outer tube. Such heating cartridges with a double-walled, tube-shaped metal housing are closed at the end with an annular cover. Such cartridge heating devices with a double-walled tube, i.e., hollow cartridges, are particularly suitable for heating cylindrical bodies, but also as continuous-flow heating devices for fluids or gases.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1A is a side perspective, partial cross-sectional view of a first example embodiment of a heating cartridge according to the preferred invention in a partially broken sectional view before compaction,

FIG. 1B is to side perspective partial cross-sectional view of the heating cartridge shown in FIG. 1A after compaction,

FIG. 1C shows a side elevational, partial cross-sectional view of the heating cartridge of FIG. 1A, i.e., before compaction,

FIG. 1C B-B is a cross-sectional view of the heating cartridge of FIG. 1C, taken along line B-B of FIG. 1C,

FIG. 1C, Detail A is a magnified portion of FIG. 1C, taken from within circle A of FIG. 1C, FIG. 1D shows a side-elevational, partial cross-sectional view of the heating cartridge of FIG. 1B, i.e., after compaction,

FIG. 1D D-D is a cross-sectional view of the heating cartridge of FIG. 1D, taken along line D-D of FIG. 1D,

FIG. 1D, Detail C is a magnified portion of FIG. 1D, taken from within Circle C of FIG. 1D,

FIG. 1E is a magnified cross-sectional view of a portion of the heating cartridge of FIG. 1C,

FIG. 1F is a magnified cross-sectional view of a portion of the heating cartridge of FIG. 1D,

FIG. 1G is a magnified cross-sectional view of the heating cartridge from FIG. 1A in an area of a slot with cut edges running perpendicular to the metal housing,

FIG. 1H is a magnified cross-sectional representation of the heating cartridge similar to FIG. 1G with cutting edges running oblique and parallel to one another,

FIG. 1I is a magnified cross-sectional representation of the heating cartridge similar to FIG. 1G with cutting edges positioned at an angle to one another,

FIG. 2A is a side perspective, partial cross-sectional view of a second example embodiment of a heating cartridge in a partially broken view before compaction,

FIG. 2B is a side perspective, partial cross-sectional view of the second example embodiment of the heating cartridge of FIG. 2A after compaction,

FIG. 2C shows a side elevational, cross-sectional view of the heating cartridge of FIG. 2A,

FIG. 2C B-B is a cross-sectional view of the heating cartridge of FIG. 2C, taken along line B-B of FIG. 2C after compaction,

FIG. 2C, Detail A is a magnified portion of FIG. 2C, taken from within circle A of FIG. 2C after compaction,

FIG. 2D shows an alternative side elevational, cross-sectional view of the heating cartridge of FIG. 2A,

FIG. 2D D-D is a cross-sectional view of the heating cartridge of FIG. 2D, taken along line D-D of FIG. 2D,

FIG. 2D Detail C is a magnified portion of FIG. 2D, taken from within circle C of FIG. 2D,

FIG. 3A is a side perspective, exploded view of a third example embodiment of a heating cartridge,

FIG. 3B is a cross-sectional view of the heating cartridge of FIG. 3A before the heating cartridge is compacted,

FIG. 3C is a cross-sectional view of the heating cartridge of FIG. 3A after compaction,

FIG. 4 is a side perspective view of a tube-shaped body from which a heating element blank according to FIGS. 1A to 1F has been cut out,

FIG. 5 is a side perspective view of a heating element blank as used in the embodiment of FIGS. 2A to 2D,

FIG. 6A is a side elevational view of a plate-shaped body from which a heating element structure is cut out,

FIG. 6B is a top plan view of a heating element structure cut out from the plate-shaped body of FIG. 6A,

FIG. 6C is a side perspective view of a heating element blank that has been bent from the heating element structure of FIG. 6B,

FIG. 7A is a side perspective view of another embodiment of a heating element blank in accordance with a preferred embodiment of the invention,

FIG. 7B is a side elevational, partial cross-sectional view of a heating cartridge of a further example embodiment in a partially broken view with an inserted heating element blank according to FIG. 7A,

FIG. 7C is a detailed cross-sectional illustration of an area taken from within box E of FIG. 7B,

FIG. 8 shows various cross-sectional views of the heating conductor according to the heating element blank of FIG. 7A with indented features,

FIG. 9A shows a side perspective view of the heating element blank of FIG. 6C in a first processing step,

FIG. 9B shows a side perspective view of the heating element blank of FIG. 6C in a second processing step,

FIG. 9C shows a side elevational, partial cross-sectional view of a heating cartridge in accordance with a preferred embodiment of the present invention utilizing the heating element blank of FIG. 6C in a third processing step,

FIG. 9D shows a side elevational, partial cross-sectional view of the heating cartridge of FIG. 9C in a fourth processing step,

FIG. 9E shows a side perspective, exploded view of the heating cartridge of FIG. 9C,

FIG. 10A is a side perspective, exploded view of another example embodiment of a heating cartridge according to the preferred invention,

FIG. 10B is a side elevational, cross-sectional view of the heating cartridge of FIG. 10A, before compaction,

FIG. 10C is a side elevational, cross-sectional view of the heating cartridge of FIG. 10A, after compaction,

FIG. 11A is a side perspective representation of a heating device element blank in accordance with another embodiment of the preferred invention,

FIG. 11B is a side elevational, partial cross-sectional view of a heating cartridge in accordance with another embodiment of the preferred invention utilizing the heating device blank of FIG. 11A, and

FIG. 11C is a magnified, cross-sectional view of a portion of FIG. 11B taken from within box E of FIG. 11B.

### DETAILED DESCRIPTION OF THE INVENTION

In the following description of the figures, the same reference numbers designate the same parts with the same meaning, unless otherwise stated.

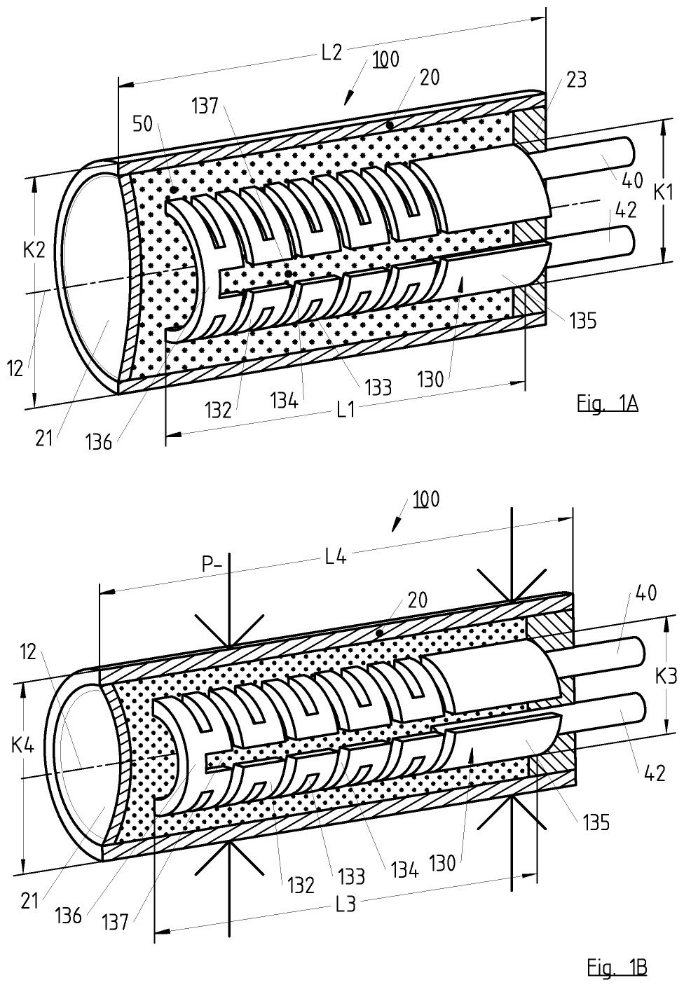

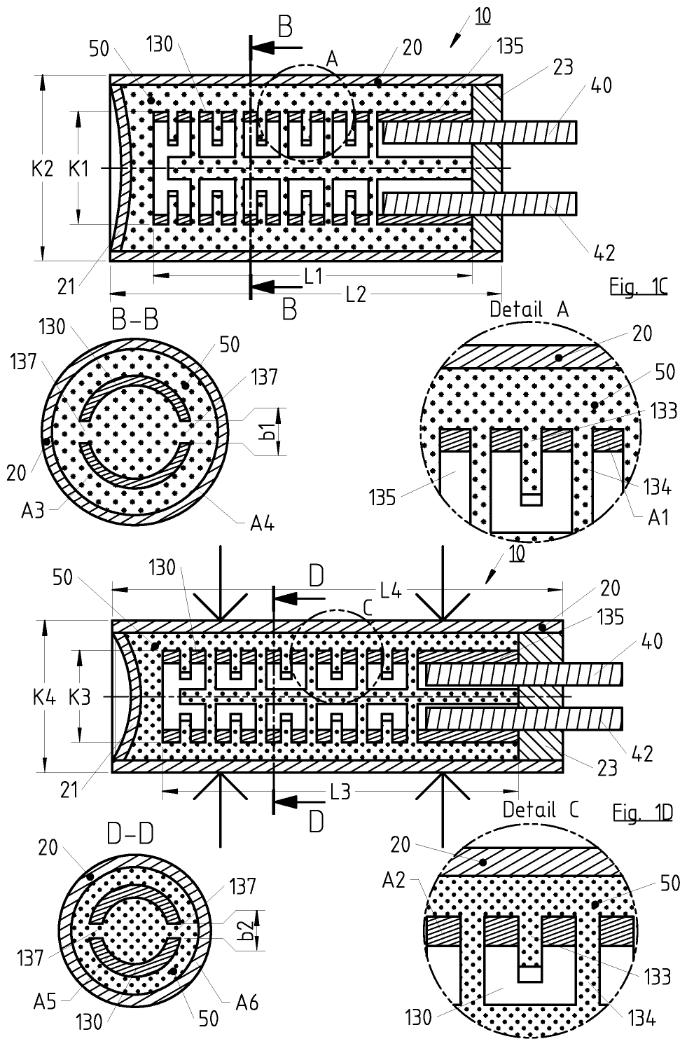

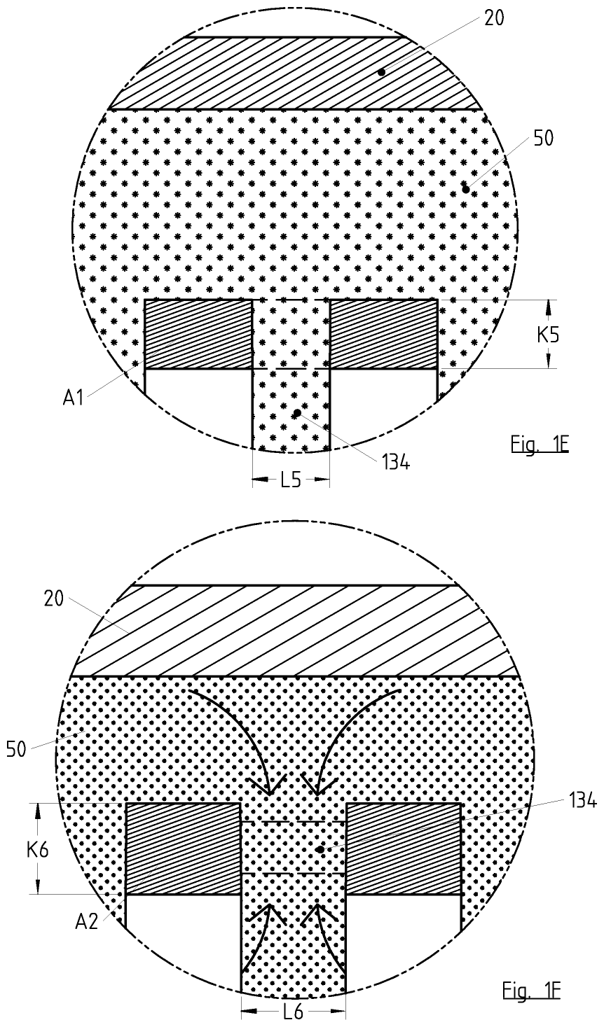

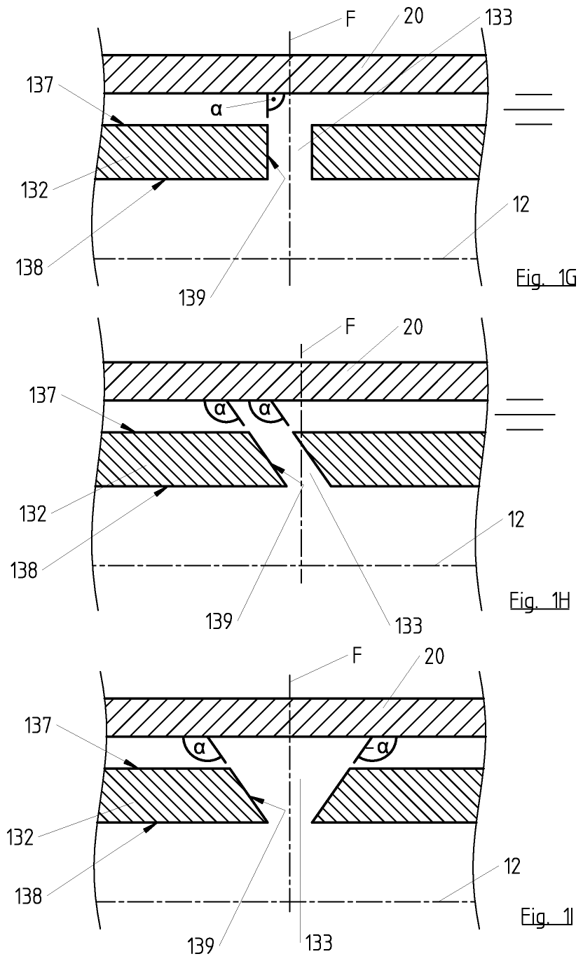

FIG. 1A shows a cartridge heating device 100 for electrical heating devices in a partially broken view. Such a heating cartridge 100 can be used, for example, in medical technology, the automotive industry, laboratory and analytical equipment, and in packaging machines. Thanks to the ability to build such heating cartridges 100 very small, it is possible, for example, to heat miniaturized plastic injection nozzles in heating flue technology.

The cartridge heating device 100 shown in FIG. 1A is depicted in a state in which the cartridge heating device 100 is not yet completely finished. The important step of compaction, which is still to be explained below, has not yet taken place in the representation of FIG. 1A. However, the heating cartridge 100 already has all the components required for subsequent operation. Thus, the heating cartridge 100 in FIG. 1A has a tube-shaped metal housing 20 which is closed at its left end with a cover 21 and at its right end with a second cover 23 preferably made of insulating material. The cover 21 can be connected integrally to the tube-shaped housing wall of the metal housing 20, but can also be attached to the metal housing 20 as a separate part. A heating element blank 130 with a heating conductor path structure or a heating conductor 132, which has a plurality of slots 133, 134 and 137, is located within the metal housing 20, centered on a longitudinal axis 12 or central axis. This heating element blank 130 has two meandering courses of a heating conductor path structure, both of which are connected to one another via a connecting web 136 in the vicinity of the cover 21 of the metal housing 20 shown on the left. In the direction of the second cover 23, the aforementioned heating conductor path structure is provided with widened conductor path ends 135, to which contact terminals 40, 42 are electrically conductively connected. The contact terminals 40, 42 are guided through corresponding openings in the cover 23 and protrude from the cover 23 on the right in the representation of FIG. 1A.

The heating element blank 130 shown in FIG. 1A is separated from a metallic, tube-shaped body by methods suitable for this purpose. FIG. 4 shows such a metallic tube-shaped body 160 with cutting lines 150, through which the heating element blank 130 can be separated from the tube-shaped body 160. The tube-shaped body 160 can have any length, so that several heating element blanks 150 can be cut out of this tube-shaped body 160 one after the other according to the introduced cut lines 150.

In addition to the cutting lines 150 required to produce the heating element blank 130, slot regions 30, 133′, 134 and 137′ are also marked in FIG. 4, in which the material of the tube-shaped body 160 is present in the illustration in FIG. 4. This material, however, is cut out after the slots 150 are produced and forms cutting waste. After these slot areas 133′, 134′, 137′ have been cut out, the heating element blank 130 shown in FIG. 1A with the slots 133, 134 and 137 remains.

It should be noted at this point that FIG. 1A, as well as FIG. 4, describes a certain design of a heating element blank 130. The present invention, however, is not limited to such a design of the heating element blank 130. Rather, there are a wide variety of variants for producing such a heating element blank 150, which can be cut out not only from a tube-shaped body, but also as a plate-shaped body.

For the purpose of disclosure, reference is hereby expressly made to German Patent Application No. DE 10 2019 127 753.1, in which a wide variety of variants for producing a heating element blank from a plate-shaped or tube-shaped body is described. All the variants mentioned there are also suitable for use in a heating cartridge, as will be explained further, within the scope of the present invention.

Coming back to FIG. 1A, the mentioned heating element blank 130 is inserted into the metal housing 20. This heating element blank 130 has a heating conductor path structure which is denoted by a length L1 in FIG. 1A. The diameter or the height of this heating element blank 130 is marked with the reference symbol K1. The length of the entire cartridge heating device 100 is L2. The outer diameter of the heating cartridge 100 is K2. As can also be seen from FIG. 1A, an insulating material suitable for compaction and suitable as a heat conductor is filled into the free space between the heating element blank 130 and the metal housing 20. Insulating granulate, such as Magnesium Oxide (MgO) granulate, ceramic granulate, and also boron nitride granulate, is particularly suitable as a material for this application.

After the insulating granulate 50 has been filled in, the heating cartridge 100 prepared according to FIG. 1A is subjected to a special compaction process. For this purpose, the heating cartridge 100 prepared from FIG. 1A is exposed to high and large area pressures from the outside. This is indicated by the arrows labeled T in FIG. 1B. This pressure can be applied, for example, using rollers or suitable rolling machines or suitable pressing methods, for example using press jaws. The purpose of this compaction is ultimately to produce a heating cartridge 100 that has the desired electrical parameters and also the intended geometric dimensions. The compacting is thus carried out until, on the one hand, the material 50 to be compacted is optimally maximally compacted and the heating cartridge 100 has reached its planned final dimensions.

As can be seen particularly clearly from FIG. 1B and is particularly illustrated in connection with FIGS. 1C and 1D and also 1E and 1F, the geometric dimensions of the heating cartridge 100 change significantly as a result of the compaction process. It should be noted in connection with the sectional illustrations in FIG. 1B and FIG. 1D that, for reasons of clarity, the insulating material 50 which is also present inside the heating element blank 130 is of course present.

However, it was deliberately omitted from the drawing in the area of the individual heating coils in order to be able to better explain the present invention and the structure of the heating cartridge.

Both the heating element blank 130 and the entire heating cartridge 100 each extend to a length L3 and L4, respectively.

On the other hand, both the heating element blank 130 and the heating cartridge 100 experience a change in height, namely a reduction in height to the height K3 of the heating element blank 130 and to a height K4 of the metal housing 20. As part of the compaction and the diameter reduction of the metal housing 20, the cover 21 arches inward, such as FIG. 1C shows, toward the heating device element blank 130. The opposite cover 23 undergoes a change in thickness. The slots 133, 134, and 137 also change in width. Thus, the slots 133, 134 between the meandering course of the heating conductor path structure are widened, as shown in the two detail views, detail A in FIG. 1C before compaction and in FIG. 1D after compaction. The slots 133, 134 become wider, while the slot 137, which is machined parallel to the longitudinal axis 120 in the heating element blank 130, becomes narrower. The slot width of this longitudinal slot 137 is indicated in sections B-B of FIG. 1C and D-D in FIG. 1D with the width indications b1, b2. The cross section of a heating conductor of the heating element structure of the heating element blank 130 also undergoes a change in thickness, namely an increase in thickness, as a result of the compaction, as shown by the reference symbols A1, A2, A3, and A5 in FIGS. 1C and 1D. The wall of the metal housing 20 also undergoes a change in thickness according to the reference symbols A4 and A6 in FIG. 1C and FIG. 1D.

FIGS. 1E and 1F show the change in thickness of the cross sections of the heating element conductor structure of the heating element blank 130, once again enlarged.

The metal housing 20 of the heating cartridge in the area of a slot 133 of the heating element blank 130 is shown enlarged in FIG. 1G. A section of the heating conductor 132 can be seen with two coils shown in section, which are separated by the slot 133. The heating conductor 132 has an upper surface 137 and a lower surface 138 which is closer to the longitudinal axis 12. Both surfaces 137 and 138 are parallel to one another and also parallel to the inner wall of the tube-shaped metal housing 20. The cut surface 139 connecting the two surfaces 137 and 138 is parallel to the opposite cut surface of the heating conductor 132. Both cut surfaces 139 are parallel to a cross sectional surface F, which is aligned orthogonal to the tube-shaped wall of the metal housing 20. The right angle is indicated in FIG. 1G with the reference symbol a. The cut surfaces 139 result from the cutting out of the previously mentioned tube-shaped or plate-shaped body.

Another example embodiment is shown in FIG. 1H, in which the cut edges are not arranged parallel to the surface F, but are aligned parallel to one another. The angle α of the cutting edges 139 is now approximately 130°. As can be seen, the cutting edges 139 of the heating conductors 132 lying opposite one another are aligned parallel to one another.

A third example embodiment of how the cut edges or cut surfaces 139 can be aligned with one another is shown in FIG. 1I. Here the cut surfaces 139 are not aligned parallel to one another, but at an angle to one another. The cutting edge 139 shown on the left in FIG. 1I has the cutting angle α as in FIG. 1H. The opposite cut surface has an angle of −α to the surface F.

In principle, cutting angles α can be selected which are aligned between 15° and 165° in relation to the cutting plane F. Cutting angles of 30° to 150° are more favorable, cutting angles of 60° to 120° are particularly favorable. The oblique selection of this cutting angle in relation to the cutting plane F increases the surface area of the cut surfaces 139 and thus also reduces the stress on the cutting edges during compaction.

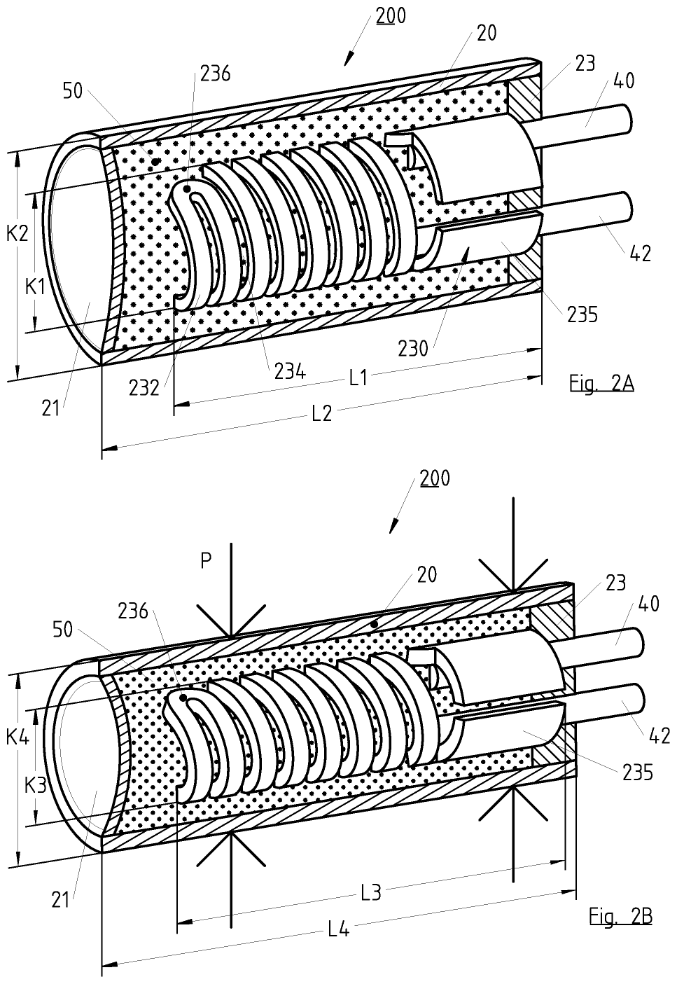

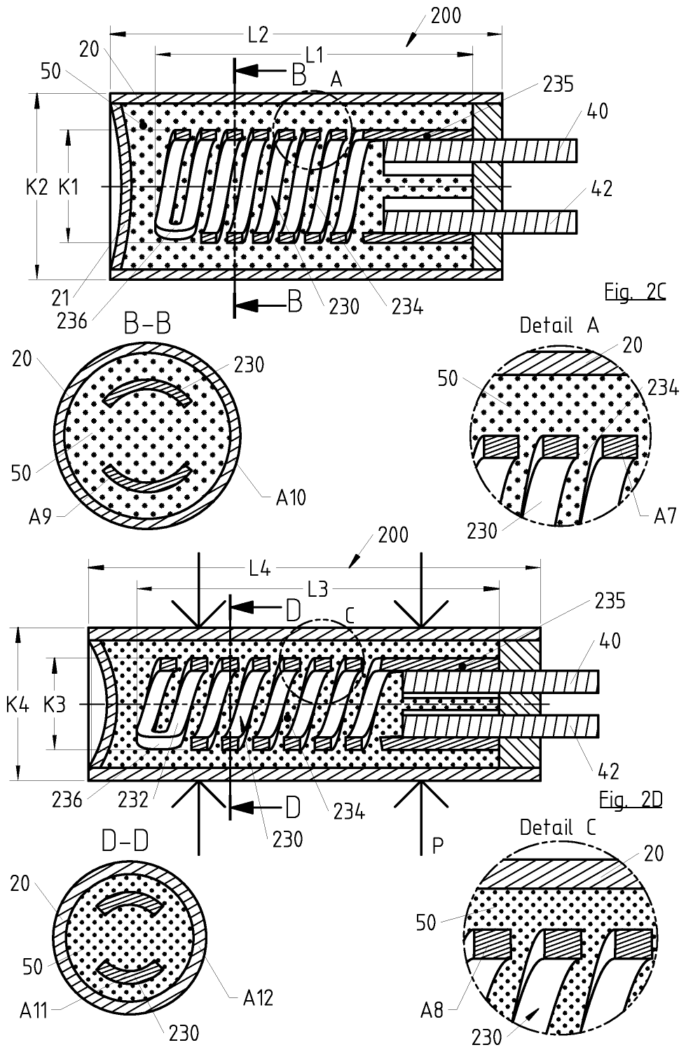

A second example embodiment of a heating cartridge 200 according to the invention is shown in FIGS. 2A, 2B, 2C, and 2D.

This heating cartridge 200 differs essentially from the heating cartridge 100 described above by the use of a differently designed heating element blank 230. The heating element blank 230 is now equipped with a bifilar heating conductor structure, but, as the detailed representation of FIG. 5 shows, again consists of a metal, tube-shaped body 260 separated by suitable separation methods. Suitable separating processes are, for example, laser cutting, water jet cutting, micro water jet cutting, etching, punching, or sawing.

FIG. 5 again shows the separating or cutting lines 250 required for the production of the heating element blank 130 as well as those areas 234′ and 240 which represent cutting waste after separating from the tube-shaped body 260. FIG. 5 shows the broadened conductor path ends 235 and the heating conductor paths 232 of the heating element blank 230. The heating conductor path structure shown in FIG. 5 has a U-shaped connecting web 236, on which the outgoing heating conductor winding reverses again.

The representation of FIG. 2A shows this heating element blank 230 inserted into the metal housing 20 with a spiral slot 234, the two conductor path ends 235 electrically connected to the contact terminals 40, 42, the connecting web 236 and the heating conductor path structure 232. The heating element blank 230 is, in turn, to be surrounded by insulating granulate to be compacted. FIG. 2A shows the cartridge heating device 200 prior to compaction.

FIG. 2B shows the heating cartridge 200 shown in FIG. 2A after compaction has taken place. The height reductions from K1 to K3 of the heating element blank 130 and the metal housing 20 from K2 to K4 appear again. The resulting changes in length of the heating element blank 230 and the metal housing 20 are again marked in FIG. 2B by the reference symbols L3 and L4.

FIGS. 2C and 2D show details of this arrangement. The changes in cross section of the heating conductor path structure of the heating element blank 230 are marked with the reference symbols A7 to A12.

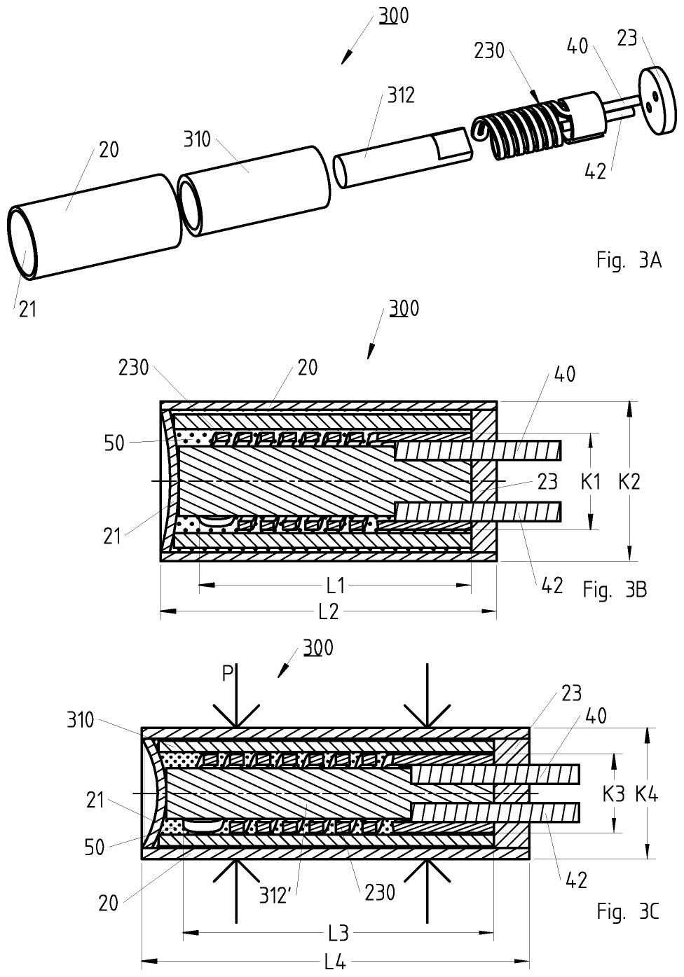

A third example embodiment of a heating cartridge 300 is shown in FIGS. 3A, 3B, and 3C. This cartridge heating device 300 differs from the two aforementioned example embodiments in one essential point, namely in the realization of the material to be compacted within the metal housing 20.

As FIG. 3A shows in a perspective view, the heating cartridge 300 has the already known metal housing 20 with the two covers 21 and 23. The heating element blank 230 from the second example embodiment is used here as an example. However, an insulating rod 312 is now pushed into the interior of the heating element blank 230 and an insulating tube 310 is additionally inserted between the metal housing 20 and the outer circumference of the heating element blank 230. The insulating rod 312 and the insulating tube 310 may each be made of a porous ceramic material, for example. In addition, according to FIG. 3B, insulating granulate 50, as described above, is filled into the gap in order to avoid any empty space, i.e., space filled with air, as much as possible. The interior of the heating cartridge 300 filled in this way is then subjected to a compaction process, which is again indicated by the arrows P in FIG. 3C. The previously described changes in length and height again result for the heating cartridge 300 finished in this way. The same applies to the heating element blank 230.

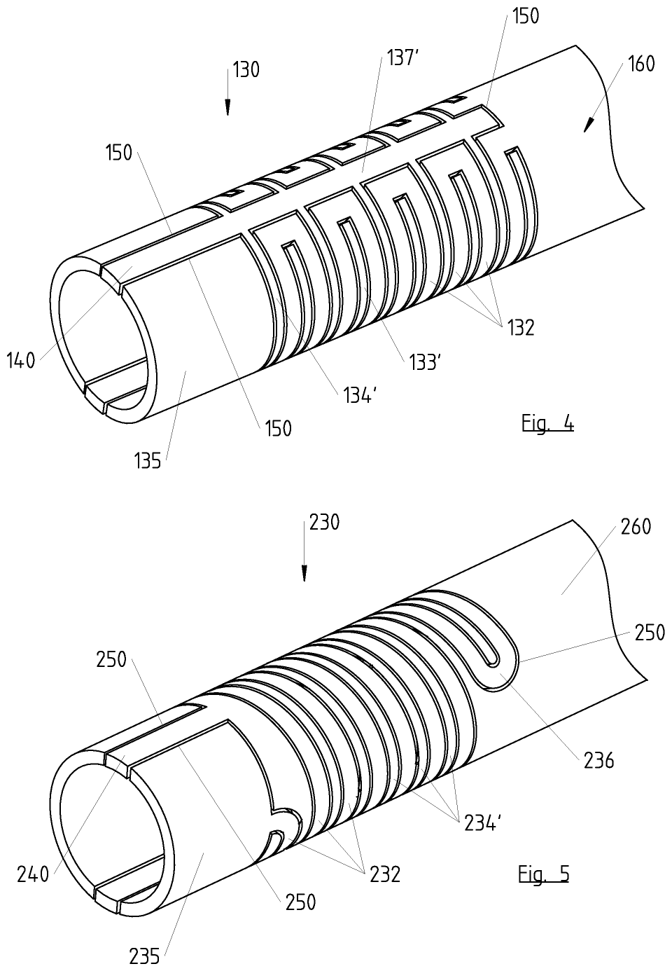

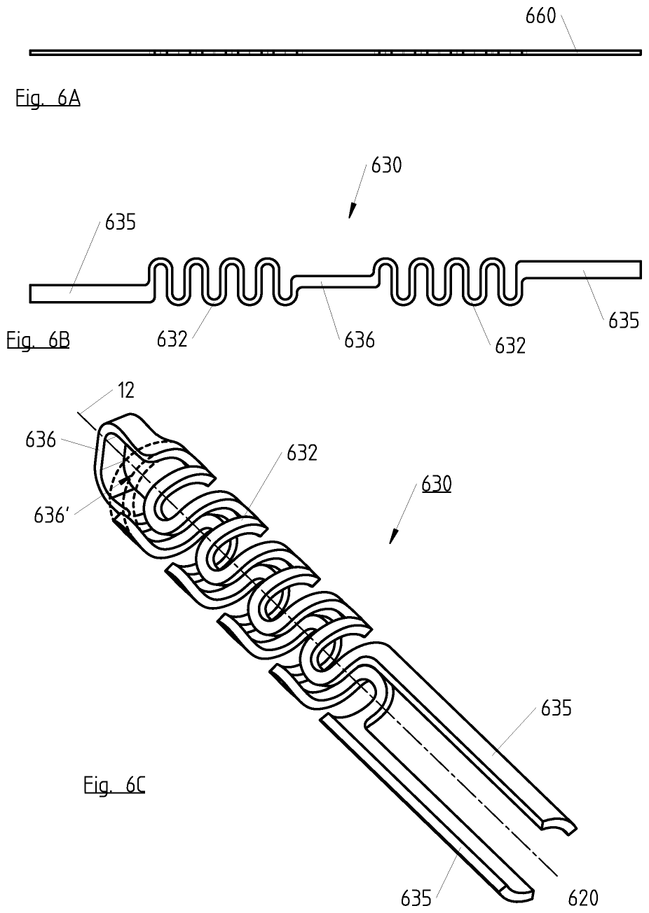

Although it was assumed in the previous example embodiments that the heating element blank 130, 230 was cut out of a tube-shaped body 160, 260, it is also within the scope of the present invention for the heating element blank to be cut out of a plate-shaped material. This is illustrated in FIG. 6A which shows, for example, a metallic plate of copper material or the like in side view. Such a plate can also be separated from a coiled metal strip.

A heating conductor path structure, for example, as illustrated in FIG. 6B, is cut out of the plate-shaped body 660 of FIG. 6A. This heating conductor path structure has two meandering line sections 632 which are connected to one another in the center via a connecting web 636. The two sections 632 each have conductor path ends 635 on the left and right. An alternative embodiment of the connecting web is shown in dashed lines in FIG. 6C and is provided with the reference number 636′. This dashed variant has the advantage that the heating element blank 630 can also be separated from a tube-shaped body.

The heating conductor path structure produced in this way is then bent several times to form a heating element blank 630 according to FIG. 6C. For this purpose, a U-shaped bend is made in the area of the connecting web 636, so that the two sections 632 lie on top of one another. These two sections with the meandering heating conductor courses are then bent towards one another about the longitudinal axis 620, producing the profile of the entire heating conductor path structure and thus of the heating element blank 630, as shown in FIG. 6C.

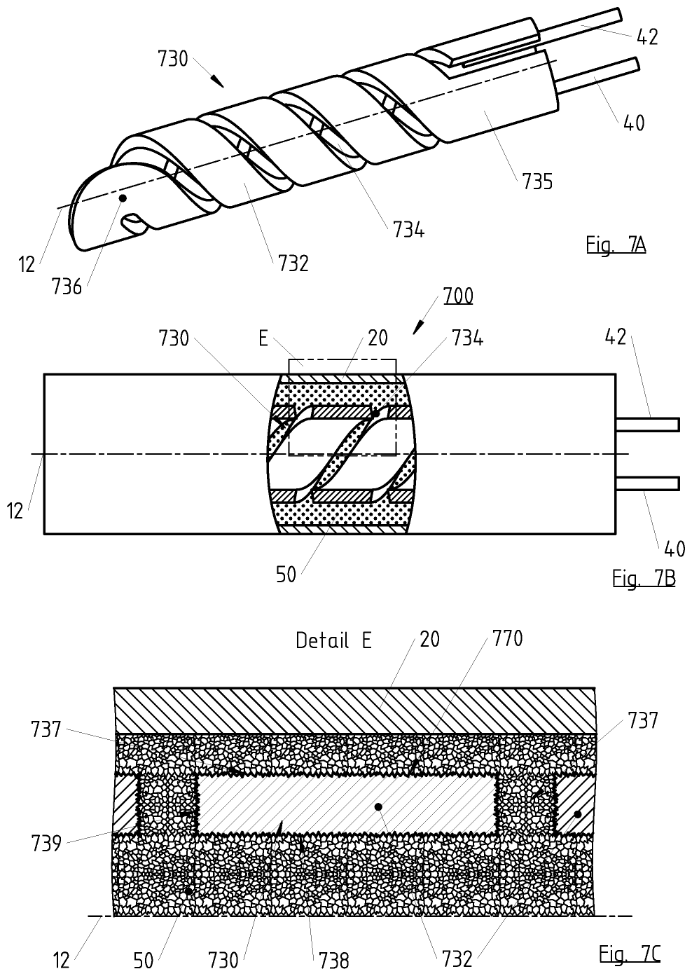

Another example embodiment of a heating cartridge according to the invention is explained in connection with FIGS. 7A, 7B, and 7C. FIG. 7A shows a perspective view of a heating element blank 730 which is similar to the heating element blank 230 in FIG. 2A. However, the individual heating coil or the heating conductor 732 of one winding is now selected to be significantly wider in the direction of the longitudinal axis 12 than in the example in FIG. 2A. However, this heating element blank 730 also has a U-shaped connecting web 736, the already mentioned heating conductor 732 and the slots 734 lying between the individual coils of the heating conductor 732.

The heating element blank 730 has two conductor path ends 735 to which the contact terminals 40, 42 are connected.

According to FIG. 7B, the heating element blank 730 designed in this way is inserted into a tube-shaped metal housing 20, from which the contact terminals 40, 42 protrude in the manner already explained. As can be seen clearly in the partially broken top view of FIG. 7B, compactable material 50 is filled in between the metal housing 20 and the heating element blank 730, it being assumed that the compaction of this material 50 and the associated dimensional changes of the heating cartridge 700 have already taken place.

The detail marked with the reference E in FIG. 7B is shown enlarged in FIG. 7C. The reference symbols already explained continue to apply. The heating conductor 732 has the two surfaces 737 and 738, which are parallel to one another, as well as cut surfaces 739 to the left and right of them. In this example embodiment, the cut surfaces 739 are parallel to one another. The material 50 that has already been compacted is marked with the reference number 50. It can be clearly seen in FIG. 7C that both the surfaces 737 and 738 and the cut surfaces 739 have an enlarged surface due to the compaction, in that irregularly distributed indented features 770 are provided on these mentioned surfaces.

The efficiency of the heating cartridge is significantly improved by these indented features, i.e., heat is transferred in an optimum way from the heating element blank 730 via the compacted material 50 to the metal housing 20.

Four different variants of indented feature are shown in FIG. 8. The indented features are marked with reference number 770. Depending on how strong the pressure P is set when compacting the preassembled heating cartridge, the indented features 770 become more or less pronounced. In addition, the type and design of the indented features 770 also depends on which compactable material 50 is filled into the metal housing 20 of the heating cartridge 700. It has been found that particularly strong indented features 770 are achieved during compaction if MgO granules are used. When compacting porous ceramic material, in particular, ceramic tubes or ceramic rods, the indentations are significantly smaller.

It should be noted for the method according to the invention for producing the described heating cartridges 100, 200, 300 that the compaction is carried out in such a way that the length of the heating element blank 130, 230, 630 and/or the metal housing 20 increases by between approximately 1% and approximately 15% and/or a height reduction of the heating element blank 130, 230, 630 and/or the metal housing 20 of approximately 5% to approximately 25% respectively. In addition to the method according to the invention, the present invention also includes a heating element blank 130, 230, 630, which is formed from a tube-shaped or plate-shaped and electrically conductive body 160, 260, 660 by machining, in that the tube-shaped or plate-shaped body 160, 260, 660 results in a deformable heating conductor path structure with a first overall length L1 and a first height K1 and with at least two conductor path ends 135, 125, 635 and this heating element blank 130, 230, 630 designed in this way is used in the aforementioned method.

A significant advantage of the method according to the invention is that due to the use of a heating element blank 130, 230, 630, 730 which was cut out of a plate-shaped or tube-shaped metallic body 160, 260, 660, the cut edges due to the compaction provide an optimal contribution to the heat transfer to the metal case 50. After the compaction, highly compacted insulating material rests on these cut edges, which promotes good heat transfer from the heating element blank 130, 230, 630, 730 to the metal housing 50. In addition, due to the fact that the heating element blank 130, 230, 630, 730 according to the invention can have almost any cross-sectional shape, in contrast to conventional heating wires, its design can be highly variable in order to enable optimal heat transfer.

It should also be pointed out that in the case of the heating cartridges according to the invention, the tube-shaped metal housing and the heating element blank are mounted parallel to one another, i.e., have the same direction of extension. The cut surfaces can be arranged entirely or partially at right angles to the outer surface of the tube-shaped metal housing. It is also possible to completely or partially arrange the surfaces of the heating element blank that are not machined by cutting parallel to the outer casing of the metal housing. Finally, it is also possible to design the tube-shaped metal housing as an electrical return conductor for the heating element or to provide several heating circuits for the heating element.

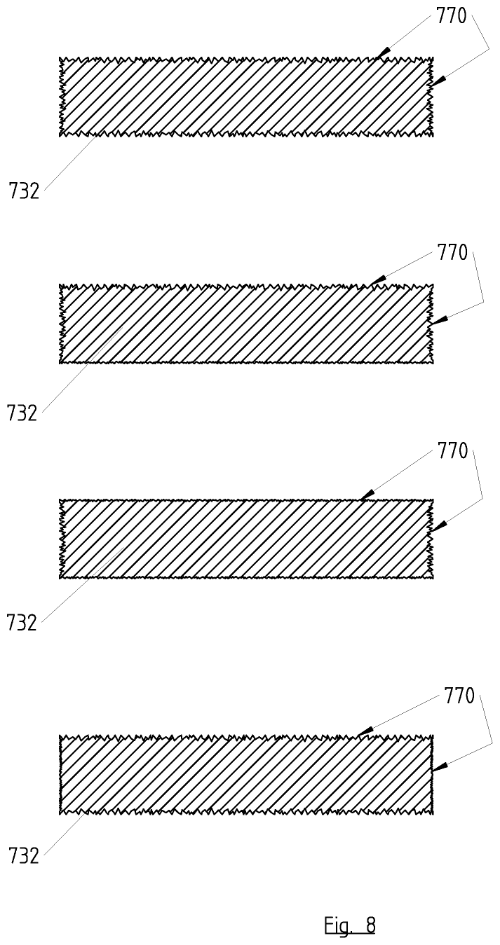

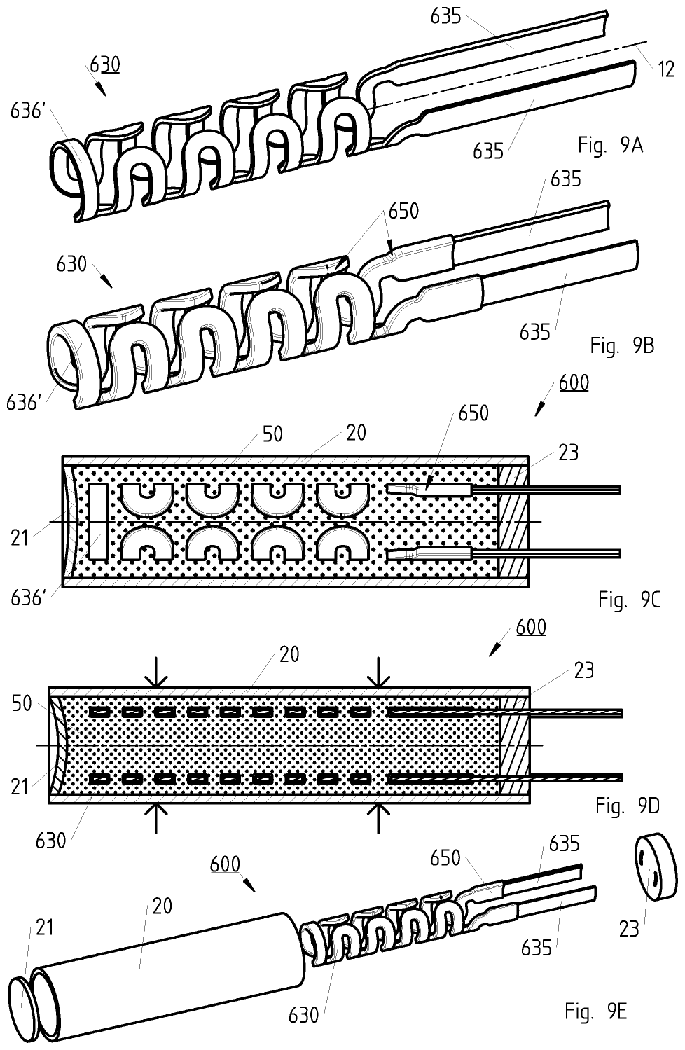

Various production steps are shown in FIGS. 9A to 9E in order to produce a heating cartridge 600 as proposed by the present invention. The heating element blank 630 already known from FIG. 6C is shown again in a perspective view in FIG. 9A. The connecting web 636′ is curved and runs at least approximately concentrically about the central axis 12. As explained, this heating element blank 630 is cut out of a plate-shaped or tube-shaped metallic body in a suitable manner and optionally bent.

In the example embodiment illustrated in FIG. 9E, this heating element blank 630 is covered with an insulating coating, a ceramic coating 650 in the present case. Only the conductor path ends 635 are not provided with this coating 650. Porous ceramic material is particularly suitable as the coating 650. Because of the coating 650 of the heating element blank 630, the heating element blank 630 can be inserted into the metal housing 20 without centering aids. The conductor paths of the heating element blank 630 are thus insulated from the metal housing 620.

This is illustrated in FIG. 9C. The metal housing 20 is in turn provided with the housing base 21 and the housing cover 23 on the left and right. The material 50 to be compacted is filled into the interior of the metal housing 20. In a subsequent processing step, the heating cartridge 600 prepared in this way is subjected to the described compaction process. This is illustrated in FIG. 9D. As discussed, the elongation of the metal shell 20 and the elongation of the diameter of the metal shell 20 achieved with compaction is illustrated in FIG. 9D.

FIG. 9E shows the described heating cartridge 600 in a perspective view.

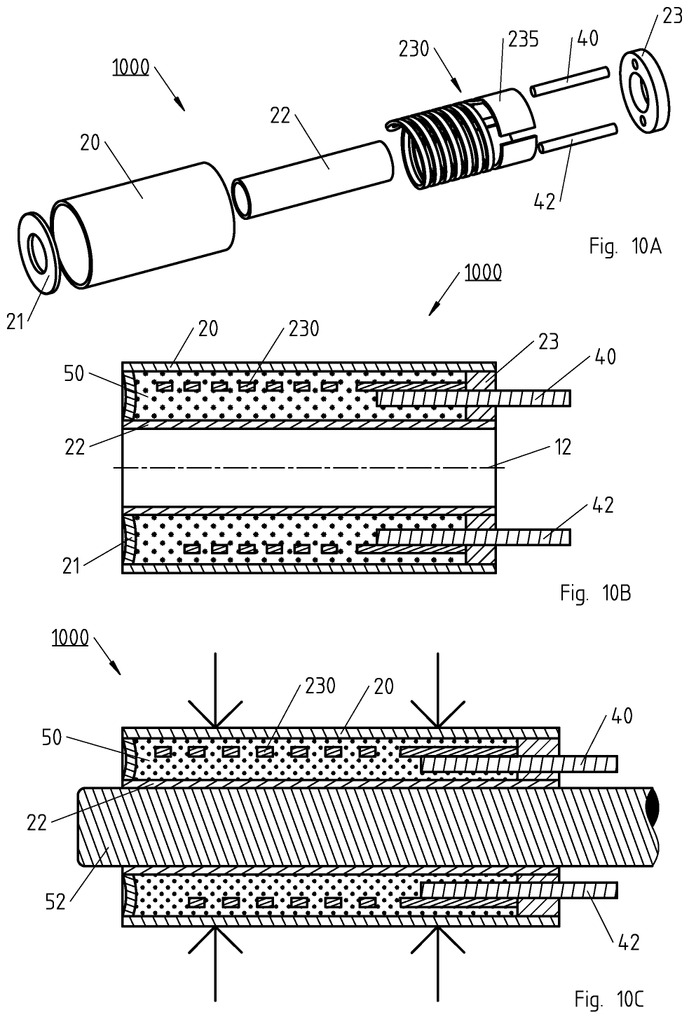

FIG. 10 shows another example embodiment of a heating cartridge according to the invention. FIG. 10A shows the associated perspective representation of the individual components, FIG. 10B a sectional view before compaction, and FIG. 10C a sectional view after compaction of the heating cartridge.

In this example embodiment, the metal housing 20 of the heating cartridge 1000 is designed as a hollow cartridge. This means that the tube-shaped metal housing 20 has a central inner tube 22. This inner tube 22 and the tube-shaped metal housing 20 are aligned concentric to the longitudinal axis 12. The heating element blank is inserted into the space between the metal housing 20 and the inner tube 22. In the example embodiment of FIG. 10A, this heating element blank 230 is a heating element blank 230, as has been explained in connection with FIGS. 2A to 2D. This heating element blank 230 in turn has two conductor path ends 235, to each of which a contact terminal 40, 42 is connected.

As can be seen from FIG. 10B, after the heating element blank 230 has been inserted, compacting material 50 is again introduced into the intermediate space between the metal housing 20 and the inner tube 22. The heating cartridge 1000 is closed on its side shown on the left in FIG. 10B with an annular housing base 21 and on its opposite end with an annular housing cover 23.

In a subsequent process step, illustrated in FIG. 10C, the cartridge heating device 1000 is subjected to a compaction step. A so-called calibrating mandrel is expediently inserted into the cavity of the inner tube 22 for this purpose. This calibrating mandrel is provided with the reference number 52 and before the actual compaction process is in close and flat contact with the inner wall of the inner tube 22, so that this inner tube 22 cannot become narrower during the subsequent compaction process. After the actual compaction process, the calibrating mandrel 52 is removed so that the completed heating cartridge 1000 can be pushed onto a cylindrical body, if necessary, in order to heat it up.

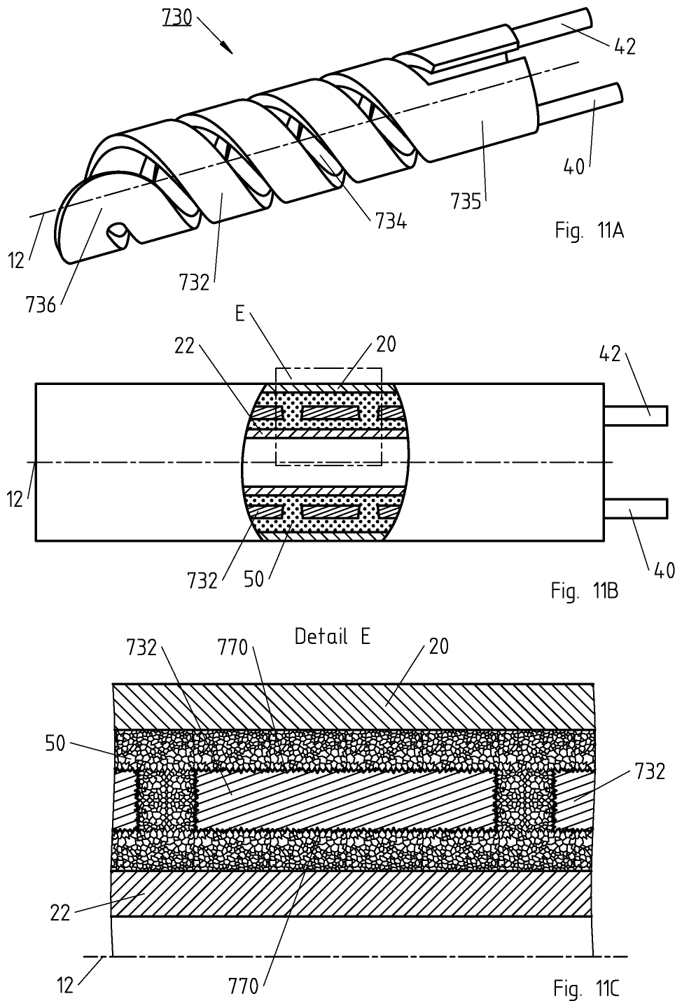

A final embodiment is illustrated in connection with FIGS. 11A, 11B, and 11C. The reference symbols already known will continue to be used. The heating device element blank in FIG. 11A corresponds to the heating device element blank 730 of FIG. 7A. Similar to the embodiment shown in FIG. 10, this heating element blank 730 is now inserted into a double-walled metal housing, that is to say, into a tube-shaped metal housing 20 with an inner tube 22 lying inside. This is shown in FIG. 11B. Detail E according to FIG. 11C again shows the compacted material and the surface structure achieved as a result of the compaction with indented features 770 in the line sections 732 of the heating element blank 730.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

12 Longitudinal axis
20 Metal housing
21 Housing bottom
22 Inner tube
23 Housing cover
40 Contact terminal
42 Contact terminal
50 Compactable material
52 Calibration pin
100, 200, 300, 600, 700, 1000 Heating cartridge
130, 230, 630, 730 Heating element blank
132, 232, 632, 632 Heating conductor
132, 232 Heating conductor area
133, 134, 137, 234, 734 Slot
133′, 134′, 137′ Slot area
135, 235, 635, 735 Conductor path end of the heating conductor
136, 236, 636, 636′, 730 U-shaped end of the heating conductor 230
137, 737 First surface of the heating element blank
138, 738 Second surface of the heating element blank
139, 739 Cross-sectional surfaces of the heating element blank
140, 240 Cut scrap
150, 250 Cut line
160, 260, 660 Tube-shaped or plate-shaped body
310 Insulating tube
312 Insulating rod
312′ Compacted material
632, 732 Sections
650 Coating, in particular, ceramic coating
770 Indented features
b1, b2 Slot width
A1-A12 Surfaces
B-B Cross section
C, D, E Detail
D-D Cross section
F
K1 Height of the heating element blank before compaction
K2 Height of the heating cartridge before compaction
K3 Height of the heating element blank after compaction
K4 Height of the heating cartridge after compaction
K5 Thickness of the heating conductor before compaction
K6 Thickness of the heating conductor after compaction
L1 Length of the heating element blank before compaction
L2 Length of the metal housing before compaction
L3 Length of the heating element blank after compaction
L4 Length of the heating cartridge after compaction
L5 Spacing between two heating conductor connections before compaction
L6 Spacing between two heating conductor connections after compaction
P Pressure
α Angle

1. A method for the production of a tube-shaped heating cartridge with an electrical heating element lying within a metal housing of the heating cartridge and extending axially relative to a longitudinal axis of the heating cartridge, wherein the heating cartridge has a specified geometric shape with a specified ohmic resistance, the method comprising:
preparing a plate-shaped or tube-shaped, electrically conductive body,
machining the body to form a heating element blank such that a deformable heating conductor path structure is formed from the body with a first length and a first height and a first conductor path end,
inserting the heating element blank into the metal housing, which has a second length and a second height, the metal housing having a tube-shape,
filling the tube-shaped metal housing with an electrically insulating and compactable material, and
compacting the filled metal housing for achieving the specified geometric shape and the specified ohmic resistance of heating cartridge with a third length increased relative to the first length and a third height reduced relative to the first height and for shaping the metal housing to a fourth length increased in comparison to the second length and a fourth height reduced relative to the second height.

2. The method according to claim 1, wherein the metal housing is closed with a cover before the compacting step.

3. The method according to claim 1, wherein the body is the plate-shaped body, from which the heating conductor path structure is cut and bent about the longitudinal axis in a subsequent step.

4. The method according to claim 1, wherein the first conductor path end is guided out of the metal housing on a face side.

5. The method according to claim 1, wherein the machining of the body for forming the heating element blank is carried out by one of the group consisting of laser cutting, water jet cutting, microwave beam cutting, etching, stamping, drilling, milling, turning, or sawing.

6. The method according to claim 1, wherein the heating conductor path structure is formed with a meander-like shape at least in some sections.

7. The method according to claim 1, wherein the heating conductor path structure has a bifilar configuration.

8. The method according to claim 1, wherein the electrically insulating and compactable material is comprised of an insulating granulate selected from the group consisting of a Magnesium oxide granulate, ceramic granulate, and boron nitride granulate, or porous ceramic material.

9. The method according to claim 1, wherein the compaction is carried out such that an increase of a length of the heating element blank and the metal housing is between approximately one percent to approximately fifteen present and a reduction in height of approximately five percent to approximately twenty-five percent.

10. The method according to claim 1, wherein the heating element blank is coated with an insulating layer comprised of a porous ceramic layer, before insertion into the metal housing.

11. The method according to claim 1, wherein a double-walled hollow tube is used as the metal housing-.

12. A heating element blank, which is formed from the tube-shaped or plate-shaped and electrically conductive body by machining, in which, from the body, the deformable heating conductor path structure is formed with the first length and the first height and also with the first conductor path end for use in the method according to claim 1.

13. A heating cartridge produced according to claim 1.

14. The heating cartridge according to claim 13, wherein the heating element blank has slots with opposing cut surfaces that are arranged orthogonal to a tube-shaped wall of the metal housing.

15. The heating cartridge according to claim 14, wherein opposing cut surfaces are arranged parallel to each other at an angle.

16. The heating cartridge according to claim 15, wherein the opposing cut surfaces face each other at different angles.

17. The heating cartridge according to claim 14, wherein the heating element blank has indented features on cover surfaces and on the cut surfaces in the final assembled and compacted state.

18. The heating cartridge according to claim 13, wherein the metal housing is constructed as a double-walled tube with an inner tube and an outer tube.

19. The heating cartridge according to claim 13, wherein the heating element blank is coated with an insulating layer comprised of a porous ceramic layer.
